(19) United States
(12) Patent Application Publication
(10) Pub. No.: US 2008/0136306 A1
(43) Pub. Date: Jun. 12, 2008

(54) FLAT PANEL DISPLAY AND SPACER FOR USE THEREIN

(76) Inventors: Takashi Naitou, Funabashi (JP); Yuichi Sawai, Mito (JP); Osamu Shiono, Hitachi (JP); Mitsuo Hayashibara, Hitachinaka (JP); Hiroshi Ito, Chiba (JP); Akira Hatori, Chiba (JP); Nobuhiko Hosotani, Mobara (JP); Shoji Shirai, Mobara (JP); Shigemi Hirasawa, Chiba (JP); Keiichi Kanazawa, Ome (JP); Hiroyuki Akata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/773,582

(22) Filed: Jul. 5, 2007

(30) Foreign Application Priority Data
Jul. 4, 2006 (JP) 2006-184531

(51) Int. Cl. H01J 1/88

(52) U.S. Cl. 313/292

(57) ABSTRACT

A spacer according to the present invention for use in a flat panel display, which includes a cathode substrate with a cold cathode electron emitting device formed thereon, an anode substrate with a phosphor formed thereon, and a spacer disposed between the cathode and anode substrates, comprises a base made of a conductive glass, and a conductive crystallized glass layer on a surface of the base. The spacer is more excellent in antistatic characteristics than conventional spacers having a conducting layer on the surface of an insulating glass base. A flat panel display according to the present invention using the spacers permits a higher voltage to be applied, thus increasing image quality.

The present application claims priority from Japanese application Ser. No. 2006-184531 filed on Jul. 4, 2006, the content of which is hereby incorporated by reference into this application.

### BACKGROUND OF THE INVENTION

1. Field of the Invention

The present invention relates to image display devices which form an image by emitting electrons into a vacuum and by colliding them with a phosphor for luminescence. More particularly, the present invention relates to flat panel displays and spacers for use therein which have a configuration in which a cathode substrate having a cold cathode electron emitting device is disposed against an anode substrate having a phosphor with a spacer interposed between them.

2. Description of the Related Art

As the image quality of information processing systems or TV broadcasting systems has increased in recent years, flat panel displays (FPDs) have caught attention because they have high brightness and precision as well as light weight and small space. Typical flat panel displays include liquid crystal displays, plasma displays and field emission displays (henceforth referred to as FEDs) which draw recent attention.

FEDs are spontaneous luminous displays which have an electron source configured with electron emitting elements of a cold cathode electron emitting device disposed in a matrix arrangement. It is known that electron emitting devices include a surface-conduction electron-emitter display (SED) type, field emission (FE) type, metal-insulator-metal (MIM) type or the like. Further, it is well-known that FE types include a Spindt type made up of a metal such as molybdenum or a semiconductor material such as silicon, a CNT type using a carbon nanotube as its electron source, or the like.

An FED includes a rear panel having an electron source formed thereon and a front panel having a phosphor formed thereon which is excited by electrons released from the electron source and emits light to a space interposed between them. It is necessary that this space is maintained at a vacuum. Therefore, a sealing frame is provided along the inner periphery of the rear and front panels. In addition, in order for the space maintained at a vacuum to withstand the atmospheric pressure, a supporting member called a spacer is disposed between both panels.

A spacer for FED is proposed in which the spacer is configured by forming a semi-conducting layer on the surface of an insulating base and further forming a loop-like conductor encircling the surface (e.g., refer to JP P1998-241606A). Another spacer for FED is proposed in which the spacer is configured by forming a conductive film on the surface of an insulating glass base (e.g., refer to JP P2004-171968A).

In a flat panel display using an electron source, a voltage applied to the anode provides a potential difference between the electron source and anode typically on the order of 3 to 10 kV. Increasing the voltage applied can provide a panel of a higher brightness and a longer lifetime but cause the spacer disposed between the rear and front panels to be more easily charged. A charged spacer leads to a phenomenon in which an electron beam traveling from the cathode to the anode is attracted toward or repelled from the spacer. This poses a problem because a shadow image of the spacer is displayed on the screen, thus deteriorating the image quality. Furthermore, a discharge is likely to occur, possibly damaging the cathode or other structural components.

In order to prevent the charging of the spacer, it is necessary to provide the spacer with some extent of conductivity. To achieve this object, above-mentioned spacer having a conducting layer on the surface of a base made of an insulating material is disclosed, e.g., in JP P1998-241606A and JP P2004-171968A. However, the antistatic characteristics of these spacers are inadequate under the condition of high potential difference.

### SUMMARY OF THE INVENTION

It is an object of the present invention to provide a flat panel display and a spacer for use therein in which the spacer is more excellent in antistatic characteristics than conventional spacers having a conducting layer on the surface of a base made of an insulating material, thereby permitting a higher voltage to be applied.

(1) According to an embodiment of the present invention, a flat panel display comprises a cathode substrate with a cold cathode electron emitting device formed thereon, an anode substrate with a phosphor formed thereon, and a spacer disposed between and supporting the cathode and anode substrates; wherein the spacer includes a base made of a conductive glass, and a conductive crystallized glass layer on a surface of the base.

(2) According to another embodiment of the present invention, a spacer for use in a flat panel display, which includes a cathode substrate with a cold cathode electron emitting device formed thereon, an anode substrate with a phosphor formed thereon, and a spacer disposed between the cathode and anode substrates, comprises a base made of a conductive glass, and a conductive crystallized glass layer on a surface of the base.

In the above inventions (1) and (2), the following modifications and changes can be made.

(i) The base of the spacer is made of a conductive glass containing a transition metal oxide, and the crystallized glass layer is formed with a crystal of the transition metal oxide being precipitated.

(ii) An average thickness of the crystallized glass layer is 3 μm or less.

(iii) An average thickness of the crystallized glass layer is 1 μm or less.

(iv) A specific resistance (electrical resistivity) of the spacer is an order of 10⁷ to 10¹⁰ Ωcm.

(v) The crystallized glass layer has protrusions and depressions at a surface thereof.

(vi) The protrusions and depressions at the surface of the crystallized glass layer have an average roughness Ra of 0.1 to 1 μm.

(vii) The transition metal oxide of the base of the spacer is at least one selected from a group consisting of vanadium oxides, tungsten oxides and molybdenum oxides.

(viii) A crystal of an oxide containing vanadium precipitates in the crystallized glass layer.

(ix) The base of the spacer includes one of: a W-V-P-O glass which contains tungsten oxides and vanadium oxides, and further contains phosphorus oxides as a vitrification component; and a W-V-Mo-P-O glass which further contains molybdenum oxides in addition to the W-V-P-O glass. Furthermore, the crystallized glass layer includes a V-P-O glass which contains vanadium oxides and phosphorus oxides with a crystal of the vanadium oxides being precipitated.

(x) An anode voltage applied to the anode substrate is within a range of 10 to 15 kV.

### Advantages of the Invention

According to the present invention, it is possible to provide a spacer using in a flat panel display, which has excellent antistatic characteristics, that is, the spacer is less likely to be charged under a higher voltage applied. Further, it is possible to provide a flat panel display with improved image quality.

### BRIEF DESCRIPTION OF THE DRAWINGS

FIG. 1 is a schematic illustration showing a side view of a spacer according to a preferred embodiment of the present invention disposed between cathode and anode substrates of a flat panel display.

FIG. 2A is a schematic illustration showing a perspective view of an overall configuration of the flat panel display according to a preferred embodiment of the present invention.

FIG. 2B is a schematic illustration showing a cross sectional view cutting along A-A line in FIG. 2A.

FIG. 3 is a schematic illustration showing a cross sectional view from front to back of the flat panel display according to a preferred embodiment of the present invention.

FIG. 4 is a schematic illustration showing a cross sectional view detailing a portion of FIG. 3.

FIG. 5 is a schematic illustration specifically showing a perspective view of an overall configuration of the flat panel display, in which a portion thereof is cut away, according to a preferred embodiment of the present invention.

FIG. 6 is a schematic illustration showing a cross sectional view cutting along B-B line in FIG. 5.

FIG. 7 is a schematic illustration showing a configuration example of a pixel in the flat panel display according to a preferred embodiment of the present invention.

FIG. 8 is a schematic illustration of an example of an equivalent circuit of the flat panel display according to a preferred embodiment of the present invention.

FIG. 9 is a graph representing a relationship between the average thickness and average roughness of the crystallized glass layer of a spacer according to an embodiment of the present invention.

FIG. 10 is a graph representing a relationship between the average thickness of the crystallized glass layer and the specific resistance of a spacer according to an embodiment of the present invention.

FIG. 11 is a graph representing a relationship between the average thickness of the crystallized glass layer and the deflection amount of electron beam of a flat panel display according to an embodiment of the present invention.

### DETAILED DESCRIPTION OF THE PREFERRED EMBODIMENTS

Preferred embodiments of the present invention will be described below with reference to the drawings. However, the present invention is not limited to the embodiments described herein.

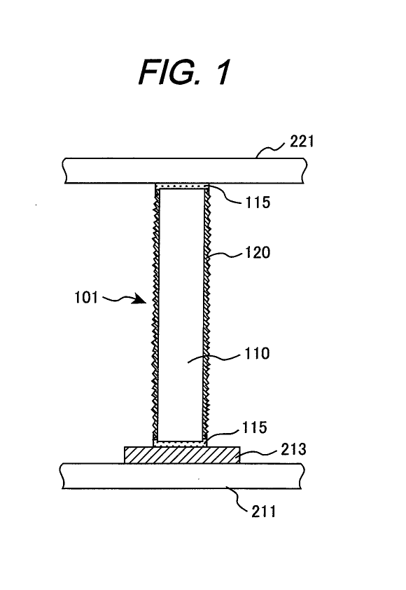

FIG. 1 is a schematic illustration showing a side view of a spacer according to a preferred embodiment of the present invention disposed between cathode and anode substrates of a flat panel display. In FIG. 1, a spacer 101 includes a base 110 made of a conductive glass and a conductive crystallized glass layer 120. FIG. 1 illustrates a case where projections and depressions are formed on the entire surface of the crystallized glass layer 120. The spacer 101 is disposed between a cathode substrate 211 in a rear panel and an anode substrate 221 in a front panel, and is bonded to each substrate with a conductive adhesive 115.

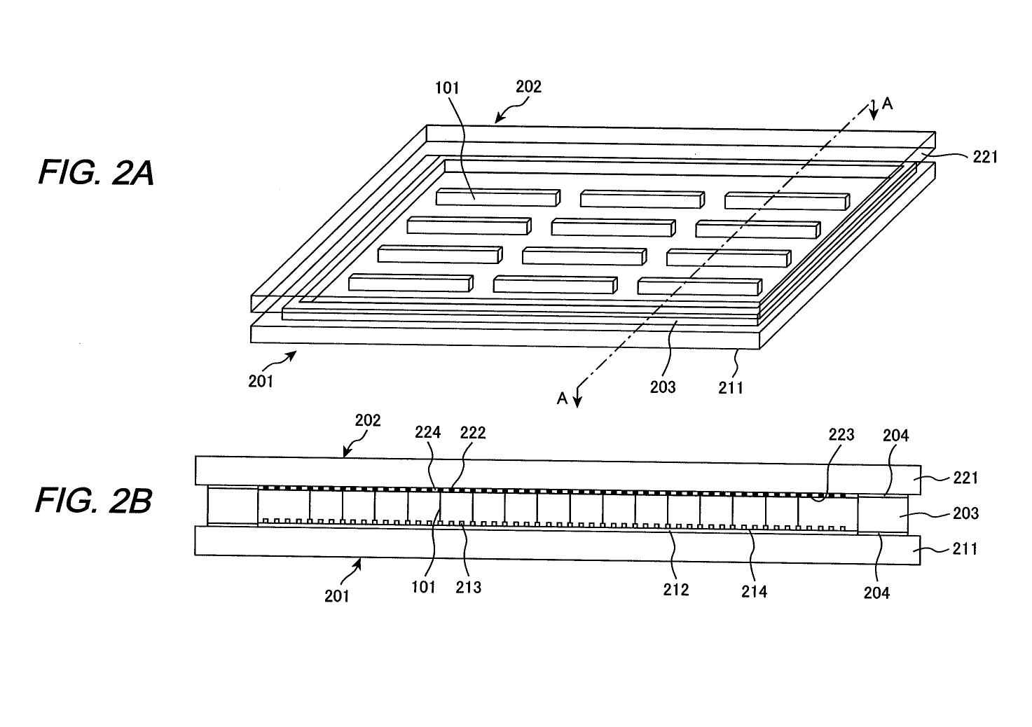

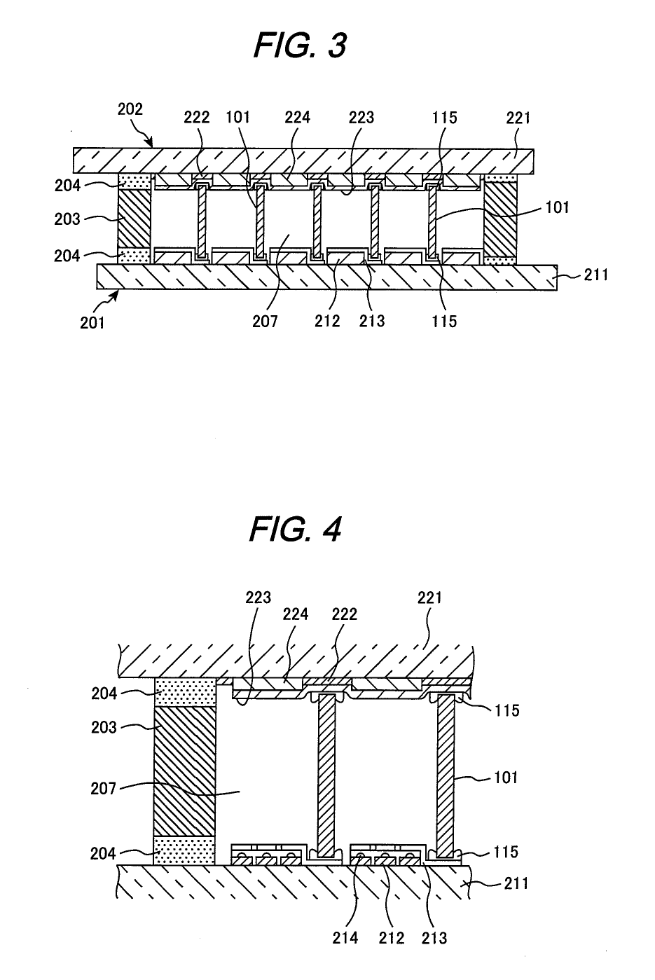

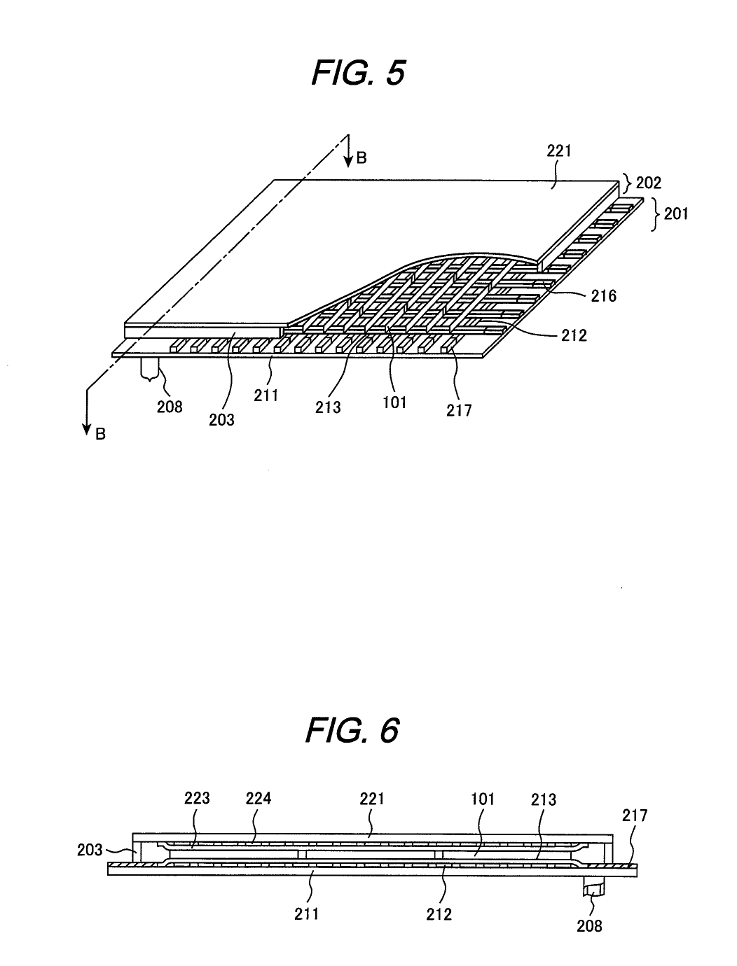

FIG. 2A is a schematic illustration showing a perspective view of an overall configuration of the flat panel display according to a preferred embodiment of the present invention. FIG. 2B is a schematic illustration showing a cross sectional view cutting along A-A line in FIG. 2A. FIG. 3 is a schematic illustration showing a cross sectional view from front to back of the flat panel display according to a preferred embodiment of the present invention. FIG. 4 is a schematic illustration showing a cross sectional view detailing a portion of FIG. 3. FIG. 5 is a schematic illustration specifically showing a perspective view of an overall configuration of the flat panel display, in which a portion thereof is cut away, according to a preferred embodiment of the present invention. FIG. 6 is a schematic illustration showing a cross sectional view cutting along B-B line in FIG. 5. As shown in FIGS. 2A to 6, a rear panel 201 has a signal line (data line, cathode electrode line) 212 and a scanning line (gate electrode line) 213 on the inner surface side of the cathode substrate 211 which is a panel base, and an electron source 214 is formed in a vicinity of the intersection of those two lines. The electron source 214 is configured such that cold cathode electron emitting elements are arranged in a matrix. At an edge of the scanning line 213 is formed a scanning line extractor 216 as shown in FIG. 5, while a signal line extractor 217 is formed at an edge of the signal line 212 as shown in FIGS. 5 and 6.

A front panel 202 has a light shielding film (black matrix) 222, an anode (metal back) 223 and a phosphor layer 224 on the inner surface side of the anode substrate 221 which is a panel base. Although the structure of the spacer 101 is represented as a single plate for simplifying in FIGS. 2A to 6, it actually includes a base and crystallized glass layer as shown in FIG. 1.

Along the inner periphery of the cathode substrate 211 and anode substrate 221 is provided a sealing frame (frame glass) 203, which is bonded to the cathode and anode substrates with an adhesive to form a sealing adhesive layer 204. Thereby, a space portion between the rear and front panels is formed. The space portion is maintained at a vacuum of typically 10⁻⁵ to 10⁻⁷ Torr, and provides a display region 207. In order to maintain the display region 207 at a vacuum, an exhaust pipe 208 is connected to a portion of the rear panel 201 as shown in FIGS. 5 and 6.

The spacer 101 is disposed between the scanning line 213 formed on the inner surface of the cathode substrate 211 and the light shielding film (black matrix) 222 formed on the inner surface of the anode substrate 221, and is bonded to them with the conductive adhesive 115. Although three spacers are disposed along the scanning line 213 as shown in FIGS. 2A to 6, it is just an example, and e.g., a single long spacer may be disposed.

The cathode substrate 211 is preferably made of glasses or ceramics such as alumina. While, transparent glasses are preferred as materials for the anode substrate 221. A glass plate is often used for the cathode substrate. The distance between the cathode and anode substrates is maintained at typically about 2 to 5 mm.

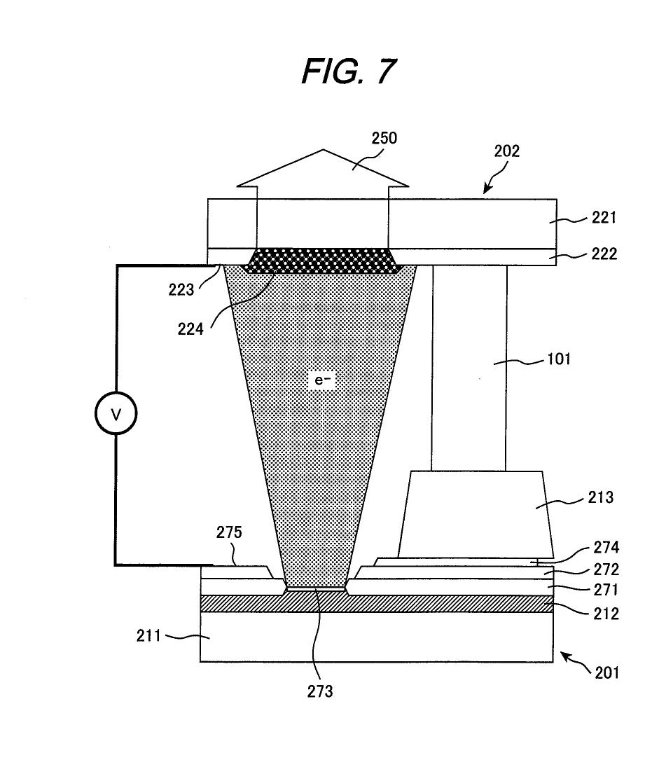

FIG. 7 is a schematic illustration showing a configuration example of a pixel in the flat panel display according to a preferred embodiment of the present invention. On the main surface (inner surface) of the cathode substrate 211 in the rear panel 201 are formed: the signal line 212 preferably of an aluminum layer which is the lower electrode of the electron source; a first insulating film 271 of an anodized oxide film formed by anodizing the aluminum of the lower electrode; a second insulating film 272 preferably of a silicon nitride (SiN) film; a power supply electrode (connecting electrode) 274; the scanning line 213 preferably of chromium; and a upper electrode 275 which is the electron source of the pixel connected to the scanning line 213.

The electron source utilizes the signal line 212 as the lower electrode, and includes a thin film portion 273 which is located on the lower electrode and forms a portion of the first insulating film 271, and a upper electrode portion 275 stacked over the thin film portion 273. The upper electrode portion 275 is formed to cover a portion of the scanning line 213 and power supply electrode 274. The thin film portion 273 is a so-called tunneling film. This configuration forms a so-called diode electron source.

On the main surface of the anode substrate 221, preferably a transparent glass substrate, in the front panel 202 are formed: the phosphor layer 224 separated from an adjacent pixel by the light shielding film (black matrix) 222; and the anode 223 preferably of a vapor deposited aluminum film. The spacer 101 is disposed between the rear panel 201 and front panel 202.

In the thus configured flat panel display, an accelerating voltage (a potential difference) between the upper electrode 275 of the rear panel 201 and the anode 223 of the front panel 202 causes a release of electrons e⁻ by an amount corresponding to a magnitude of a display data supplied from the signal line 212 as the lower electrode. The released electrons are then driven by the accelerating voltage to impinge on and excite the phosphor layer 224, which emits light 250 of a specific frequency outward through the front panel 202. In a full-color display, this unit pixel corresponds to a color sub-pixel, and one color pixel typically includes three sub-pixels of red (R), green (G) and blue (B).

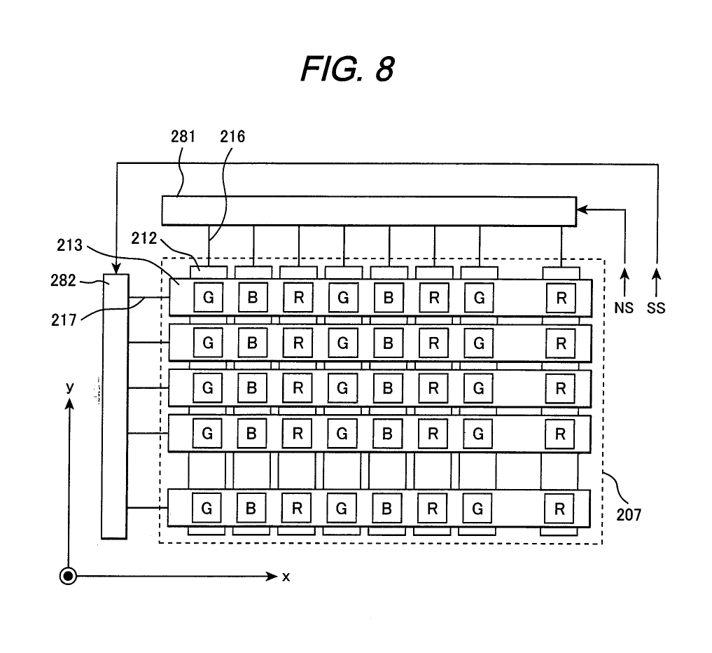

FIG. 8 is a schematic illustration of an example of an equivalent circuit of the flat panel display according to a preferred embodiment of the present invention. In FIG. 8, the region surrounded by the broken line corresponds to a display region 207, where n signal lines 212 and m scanning lines 213 are intersected with each other to form an n×m matrix. One sub-pixel is formed at each intersection of the matrix, and one color pixel includes three unit pixels (sub-pixels), i.e., one group of R, G and B in FIG. 8. The signal line 212 is connected to an image signal driver circuit 281 through the signal line extractor 216, while the scanning line 213 is connected to a scanning signal driver circuit 282 through the scanning line extractor 217. An image signal NS is inputted to the image signal driver circuit 281 from an external signal source, while a scanning signal SS is similarly inputted to the scanning signal driver circuit 282.

Thus, a two-dimensional full-color image can be displayed by supplying corresponding image signals to the signal lines 212 which intersect with the sequentially selected scanning lines 213.

As described before, in a flat panel display, a spacer is prone to be charged with electrons traveling from an electron emitting device. A charged spacer would deflect the trajectories of the electrons released from the electron emitting device, causing an image distortion phenomenon. In order to prevent the charging of the spacer, it is necessary to form a layer having some extent of conductivity on the spacer surface, thereby allowing a small electric current to flow away.

A good conductive spacer can rapidly dissipate charges after an application of a voltage is terminated. On the other hand, there may occur a thermal runaway caused by an excessive current flow, thereby damaging a panel. Even if the panel is not damaged, the power consumption of the panel increases. Here, the thermal runaway is a phenomenon in which the following actions and reactions are repeated: a spacer is heated by a current flow, which then reduces the electric resistivity of the spacer, which then increases the current flow, which further heats the spacer, which further reduces the electric resistivity and so on.

In the spacer according to the present invention, the conductive crystallized glass layer on its surface increases the thermal conductivity thereof, thus having an effect of suppressing a thermal runaway under a high voltage. In addition, the crystallization forms projections and depressions on the surface, which provides an effect of reducing the amount of deflection of electron beams. Further, it would be considered that its temperature coefficient of resistance decreases.

The spacer according to the present invention has a conductive crystallized glass layer on the surface of the base made of a conductive glass, and therefore is essentially different from conventional ones in which a conductor is simply provided on the base.

In the crystallized glass layer of the spacer of the present invention, a transition metal oxide component contained in the glass crystallizes and precipitates to form a precipitate phase. In addition, projections and depressions are formed on the surface of the crystallized glass layer. These provide the following two simultaneous effects: the crystallization increases thermal conductivity; and the projections and depressions suppress emission of secondary electrons thereby reducing the amount of deflection of electron beams. This is a notable effect not seen in conventional spacers. Further, this crystallization can reduce the absolute value of the temperature coefficient of resistance, thus offering a more reliable spacer.

The spacer of the present invention can be fabricated by, e.g., so-called spray coating in which a slurry of a conductive glass containing a crystallizable component is sprayed to the surface of a spacer base, which is directly baked and heated to the crystallization temperature for crystallization. It can be also fabricated by a three-layer preform method in which a preform for a spacer is covered with a crystallizable component on its surface, then baked while being drawn, and is thereafter heated for crystallization. Note that the fabrication method of the spacer of the present invention is of course not limited to these methods.

The spray coating and three layer preform methods will now be described in details. In the spray coating method, glass raw materials are blended, mixed and molten to prepare a glass ingot. The ingot is then processed to prepare a glass preform. The preform is loaded into a draw furnace. Below the draw furnace are placed: a spraying apparatus for spray-coating a material to form a crystallized glass layer; and a crystallizing furnace for baking and further crystallizing the spray-coated glass material. The glass preform is continuously drawn downward, on the way of which the glass preform is spray-coated with a slurry of the crystallized glass layer forming material using the spraying apparatus. Thereafter, the resulting product is further passed through the crystallizing furnace for crystallization. In this way, a spacer having a base covered with a crystallized glass layer on its surface can be fabricated.

In the three layer preform method, both side of the glass preform as prepared above is coated with a component to be crystallized and baked to form a three layer structured product. The resulting product is loaded into a draw furnace and further passed through a crystallizing furnace placed below the draw furnace to crystallize and precipitate the crystallizable component contained in the glass material covering the surface of a base. In this way, a spacer having a base covered with a crystallized glass layer on its surface is fabricated.

The thickness of the crystallized glass layer can be varied by controlling the coating amount of the crystallized glass layer forming material, e.g., the spraying amount or spraying rate in the spray coating method. As described below, experimental results showed that there was a relationship between the thickness and the condition or average roughness of the crystallized glass layers. It was found that the average roughness decreased with decreasing the thickness.

For the spacer of the present invention, the average thickness of the crystallized glass layer is preferably 3 μm or less, more preferably 1 μm or less. When a thickness of the crystallized glass layer is more than 3 μm, the spacer thickness is difficult to be controlled precisely and the crystallized glass layer is prone to be stripped from the base because of the thermal expansion difference between them. Such a problem is more unlikely to arise at the thickness of 1 μm or less. When an average thickness of the crystallized glass layer is 3 μm or less, the specific resistance of the spacer is approximately from 10⁷ to 10¹⁰ Ωcm. This improves the following problems: when a specific resistance of the spacer is less than 10⁷ Ωcm, excessive current flows through the spacer, thereby likely to cause a thermal runaway and damage the spacer; and when a specific resistance of the spacer is more than 10¹⁰ Ωcm, the spacer is easily charged thereby significantly attracting electron beams.

The average roughness of the crystallized glass layer is preferably in the range of 0.1 to 1 μm. This roughness range can be obtained at an average thickness of the crystallized glass layer ranging from 0.2 to 3 μm. When an average roughness is less than 0.1 μm, effects of suppressing beam deflection and increasing thermal conductivity become poor. On the other hand, when an average roughness is more than 1 μm, assembly accuracy of the spacers and the substrates deteriorates. The assembly accuracy is notably higher at an average roughness of 1 μm or less.

The conductive glass for use in the spacer base preferably contains transition metal oxides, more preferably at least one selected from a group consisting of vanadium oxides, tungsten oxides and molybdenum oxides as the transition metal oxides. Barium oxide, antimony oxides or the like may be optionally contained.

Vanadium oxides, tungsten oxides and molybdenum oxides all exhibit an electric conductivity in a glass; therefore, the base containing them has the electric conductivity. Of these, vanadium oxides have a highest electric conductivity. On the other hand, tungsten oxides have an effect of increasing the thermal resistance of the glass, while molybdenum oxides have an effect of reducing the secondary electron emission of the glass. Therefore, the spacer according to the present invention preferably contains tungsten oxides and vanadium oxides, more preferably all these oxides.

Oxides for vitrification are mixed in the spacer material in addition to the above-mentioned transition metal oxides. The oxides for vitrification are most preferably phosphorus oxides, and barium oxides may be contained together with phosphorus oxides. In addition, the thermal expansion coefficient of the glass can be controlled by varying the content of barium oxides.

As described above, the inventors propose that for the spacer base is used: a W-V-P-O glass which contains tungsten oxides and vanadium oxides, and further contains phosphorus oxides as the vitrification component; or a W-V-Mo-P-O glass which further contains molybdenum oxides in addition to the W-V-P-O glass.

The crystallized glass layer preferably includes a glass containing transition metal oxides with the transition metal oxides crystals precipitated. As the transition metal oxide, vanadium oxides are most preferable in view of providing an electric conductivity. Therefore, the present invention proposes that the crystallized glass layer includes a V-P-O glass containing vanadium oxides and phosphorus oxides with the crystals of vanadium oxides or vanadium-containing oxides precipitated.

In the flat panel display according to the preferred embodiments of the present invention, the spacer is less likely to be charged, which permits the anode voltage to be increased as high as 10 to 15 kV, thus increasing the image quality. An anode voltage in this range can provide a sufficient brightness, and suppress spark generation thereby preventing from damage of the spacer and wiring.

As examples of the present invention, spacers were fabricated in the following manner using spray coating: the base of the spacer included 30 mass % WO₃, 15 mass % V₂O₅, 10 mass % MoO₃, 30 mass % P₂O₅ and 15 mass % BaO; and the base had a crystallized glass layer on its surface. The crystallized glass layer included 55 mass % V₂O₅, 25 mass % P₂O₅, 10 mass % BaO and 10 mass % Sb₂O₃, with the V₂O₅ crystals precipitated. The glass base had a height of 3 mm, a thickness of 0.12 mm and a length of 730 mm.

The specific resistance of the spacers in a vacuum of 10⁻⁶ Pa was measured. The specific resistance of the base was 1.4×10⁹ Ωcm (1 kV) and that of the crystallized glass layer was 1.2×10⁷ Ωcm (1 kV). Before the crystallization of the glass layer formed on the base, the specific resistance of the layer was 9.2×10⁷ Ωcm (1 kV), which showed that the crystallization reduced the specific resistance.

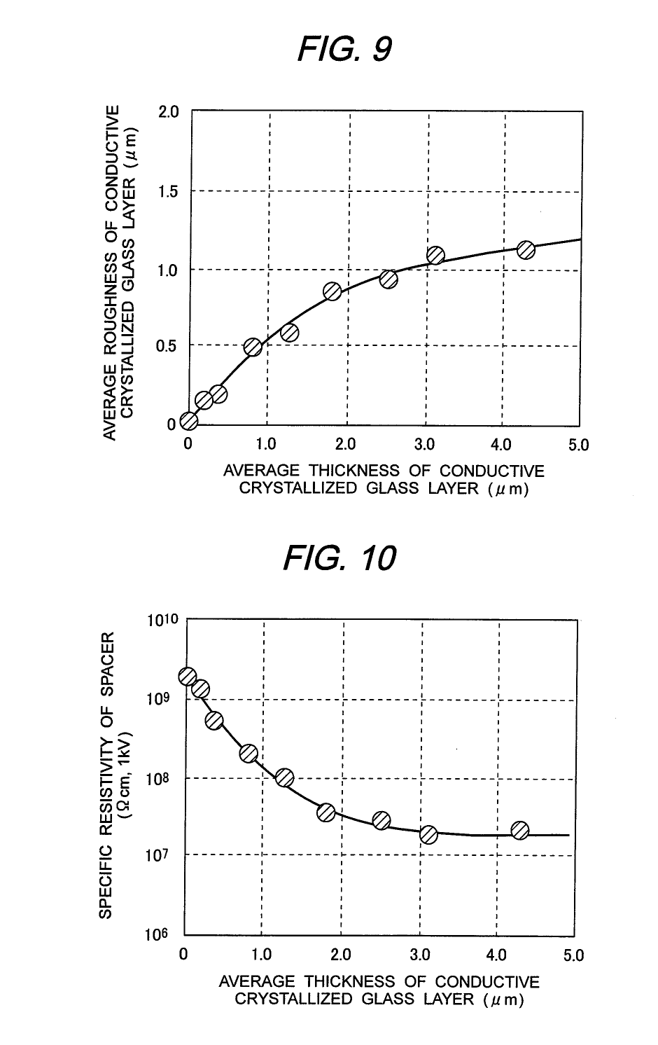

FIG. 9 is a graph representing a relationship between the average thickness and average roughness of the crystallized glass layer on the surface of the spacer, while FIG. 10 is a graph representing a relationship between the average thickness of the crystallized glass layer on the surface of the spacer and the specific resistance of the spacer. As shown in FIG. 9, it was found that the average roughness decreased with decreasing the average thickness of the crystallized glass layer. In addition, it was confirmed that the specific resistance decreased with increasing the average thickness of the crystallized glass layer, as shown in FIG. 10.

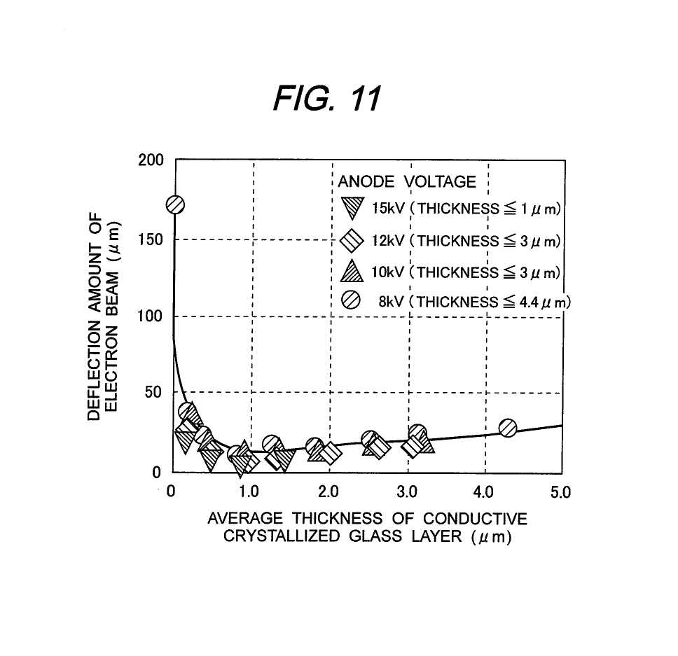

Furthermore, flat panel displays were fabricated using above spacers as other examples of the present invention. The relationship between the average thickness of the crystallized glass layer on the surface of the spacer and the deflection amount of electron beam was investigated. The results obtained are shown in FIG. 11. It was revealed that a flat panel display according to the preferred embodiments of the present invention had excellent antistatic characteristics so that the deflection amount of electron beam decreased even under a higher voltage applied, as shown in FIG. 11.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A flat panel display, comprising:
a cathode substrate with a cold cathode electron emitting device formed thereon, an anode substrate with a phosphor formed thereon, and a spacer disposed between and supporting the cathode and anode substrates; wherein: the spacer includes a base made of a conductive glass and a conductive crystallized glass layer on a surface of the base.

2. A flat panel display according to claim 1, wherein:
the base of the spacer is made of a conductive glass containing a transition metal oxide; and the crystallized glass layer is formed with a crystal of the transition metal oxide being precipitated.

3. A flat panel display according to claim 1, wherein:
an average thickness of the crystallized glass layer is 3 μm or less.

4. A flat panel display according to claim 1, wherein:
an average thickness of the crystallized glass layer is 1 μm or less.

5. A flat panel display according to claim 1, wherein:
a specific resistance of the spacer is an order of 10⁷ to 10¹⁰ Ωcm.

6. A flat panel display according to claim 1, wherein:
the crystallized glass layer has protrusions and depressions at a surface thereof.

7. A flat panel display according to claim 6, wherein:
the protrusions and depressions at the surface of the crystallized glass layer have an average roughness Ra of 0.1 to 1 μm.

8. A flat panel display according to claim 2, wherein:
the transition metal oxide of the base of the spacer is at least one selected from a group consisting of vanadium oxides, tungsten oxides and molybdenum oxides.

9. A flat panel display according to claim 2, wherein:
a crystal of an oxide containing vanadium precipitates in the crystallized glass layer.

10. A flat panel display according to claim 2, wherein:
the base of the spacer includes one of: a W-V-P-O glass which contains tungsten oxides and vanadium oxides, and further contains phosphorus oxides as a vitrification component; and a W-V-Mo-P-O glass which further contains molybdenum oxides in addition to the W-V-P-O glass,
and wherein the crystallized glass layer includes a V-P-O glass which contains vanadium oxides and phosphorus oxides with a crystal of the vanadium oxides being precipitated.

11. A flat panel display according to claim 1, wherein:
an anode voltage applied to the anode substrate is within a range of 10 to 15 kV.

12. A spacer for use in a flat panel display, which includes a cathode substrate with a cold cathode electron emitting device formed thereon, an anode substrate with a phosphor formed thereon, and a spacer disposed between the cathode and anode substrates, comprising: a base made of a conductive glass; and a conductive crystallized glass layer on a surface of the base.

13. A spacer according to claim 12, wherein:
the base is made of a conductive glass containing a transition metal oxide; and a crystal of the transition metal oxide precipitates in the crystallized glass layer.

14. A spacer according to claim 12, wherein:
an average thickness of the crystallized glass layer is 3 μm or less.

15. A spacer according to claim 12, wherein:
a specific resistance of the spacer is an order of 10⁷ to 10¹⁰ Ωcm.

16. A spacer according to claim 12, wherein:
a transition metal oxide of the base is at least one selected from a group consisting of vanadium oxides, tungsten oxides and molybdenum oxides.

17. A spacer according to claim 12, wherein:
a crystal of an oxide containing vanadium precipitates in the crystallized glass layer.

18. A spacer according to claim 12, wherein:
the base includes one of: a W-V-P-O glass which contains tungsten oxides and vanadium oxides, and further contains phosphorus oxides as a vitrification component; and a W-V-Mo-P-O glass which further contains molybdenum oxides in addition to the W-V-P-O glass,
and wherein the crystallized glass layer includes a V-P-O glass which contains vanadium oxides and phosphorus oxides with a crystal of the vanadium oxides being precipitated.

19. A spacer according to claim 12, wherein:
the crystallized glass layer has protrusions and depressions at a surface thereof.

20. A spacer according to claim 19, wherein:
the protrusions and depressions at the surface of the crystallized glass layer have an average roughness Ra of 0.1 to 1.0 μm.
